(19) United States
(12) Patent Application Publication
(10) Pub. No.: US 2009/0291409 A1
(43) Pub. Date: Nov. 26, 2009

(54) MEDICAL INSTRUMENT

(76) Inventor: Olaf Schafer, Singen (DE)

Correspondence Address: BACHMAN & LAPOINTE, P.C., 900 CHAPEL STREET, SUITE 1201, NEW HAVEN, CT, 06510, US

(21) Appl. No.: 11/721,448

(22) PCT Filed: Dec. 23, 2005
(86) PCT No.: PCT/EP2005/013953

§ 371 Date: Jun. 12, 2007

(30) Foreign Application Priority Data
Dec. 30, 2004 (DE) 20 2004 020 275.1

(51) Int. Cl. A61C 3/00

(52) U.S. Cl. 433/29

(57) ABSTRACT

A medical instrument for dental treatments using a laser that comprises at least two laser modules with different wavelengths, the modules being connected to an electronic controller. A changeover switch is situated between the electronic controller and the laser modules, the switch being used to connect the electronic controller to one or other of the laser modules.

### BACKGROUND OF THE INVENTION

The invention relates to a medical instrument for dental treatments by means of a laser, comprising at least two laser modules with different wavelengths, which are connected to control electronics, a changeover switch by means of which the control electronics can be connected to one or the other laser module being arranged between the control electronics and the laser modules.

A medical instrument of this type is known for example from DE 102 26 749 A1. Two laser modules form two separate sources for laser light with different wavelengths. If, for example, the first laser module is required, the program in the control electronics for starting the activity of this laser module is started. If, on the other hand, a laser light with a wavelength of the second laser module is desired, the program for the first laser module must first be stopped and ended, so that starting of the program of the second laser module then takes place. This requires considerable time.

Furthermore, EP 0 844 008 A1 describes a device for use in the laser treatment of biological tissue, in which a laser is provided with at least two laser modules with different wavelengths, which are connected to control electronics. A changeover switch, by which the control electronics can be connected to one or the other laser module, is arranged between the control electronics and the laser modules. This changeover switch is an electronic switch which is actuated by a control system.

The object of the present invention is to simplify and speed up the handling of the medical instrument.

### SUMMARY OF THE INVENTION

The object is achieved by the changeover switch being a foot-operated button.

The changeover switch in itself has the effect that the programs do not first have to be ended, but merely remain in a waiting position. In other words, it is possible to switch back and forth between the individual laser modules without the program of the laser that is not required at the time having to be ended. Considerable time is saved as a result.

Forming the changeover switch as a foot-operated button has the consequence that the user of the medical instrument continues to have his hands free for treating or examining the patient, while he can use his foot to switch back and forth between the individual laser modules. However, the changeover switch may take other possible forms.

For instance, it is also conceivable to provide changeover switching by voice control, which responds to a specific command. Protection is separately sought for this possibility.

Furthermore, it is conceivable for the changeover switch to be arranged on a handpiece, from which the laser light is emitted. If this takes place in the vicinity of the fingers, it is likewise easy in this way to switch back and forth between the two laser modules. In this case, it is immaterial whether only one light guide for both laser modules or two separate light guides are provided in the handpiece, or even two separate handpieces are provided.

### BRIEF DESCRIPTION OF THE DRAWINGS

Further advantages, features and details of the invention emerge from the following description of preferred exemplary embodiments and by reference to the drawing, which shows in a single FIGURE a plan view in the form of a block diagram of part of the medical instrument according to the invention for dental treatments by means of a laser.

### DETAILED DESCRIPTION

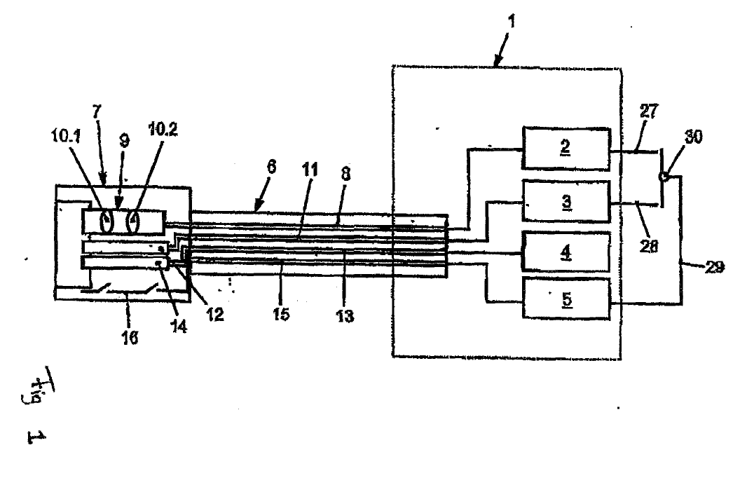

According to FIG. 1, a laser module 2 of a diode laser and a laser model 3 of an erbium:YAG laser are located in a base unit 1. Furthermore, a source 4 for a coolant and control electronics 5 are provided.

The base unit 1 is in connection with a rear part 7 by means of a common line 6. The diode laser module 2 is connected by means of a connecting line 8 to an optical element 9, in which two lenses 10.1 and 10.2 are fitted.

The erbium:YAG laser module 3 is in connection by means of a connecting line 11 with a hollow conductor 12, which preferably has a stainless steel tube in which the laser light is reflected.

A connecting line 13 from the source 4 for coolant opens out into a transmission piece 14. A connecting line 15 from the control electronics 5 is in connection with switching elements 16 for functional selection.

The laser modules 2 and 3 can be connected by means of connection lines 27 and 28, respectively, and 29 to the control electronics 5. This takes place according to the invention by means of a changeover switch 30. The changeover switch 30 is designed in such a way that it connects the control electronics 5 either to the laser module 2 or to the laser module 3.

1-4. (canceled)

5. A medical instrument for dental treatments comprising at least two laser modules each having different wavelengths and which are connected to control electronics, a changeover switch, by means of which the control electronics can be connected to one or the other of the at least two laser modules, the changeover switch is arranged between the control electronics and the at least two modules.

6. The medical instrument as claimed in claim 5, wherein the changeover switch comprises a foot-operated button.

7. The medical instrument as claimed in claim 5, wherein the changeover switch is provided on a handpiece.

8. The medical instrument as claimed in claim 5, wherein the changeover switch is voice-controlled.
